(19) United States
(12) Patent Application Publication
(10) Pub. No.: US 2011/0006524 A1
(43) Pub. Date: Jan. 13, 2011

(54) WIND TURBINE WITH STABLE POWER OUTPUT

(76) Inventor: CHUN-MU CHOU, Mituo Township (TW)

Correspondence Address: SINORICA, LLC, 2275 Research Blvd., Suite 500, ROCKVILLE, MD, 20850, US

(21) Appl. No.: 12/499,886

(22) Filed: Jul. 9, 2009

(51) Int. Cl. F03D 9/00; F03D 7/00

(52) U.S. Cl. 290/44; 290/55

(57) ABSTRACT

A wind turbine includes a plurality of superposed rotor assemblies each comprising a top first rotor, a plurality of second rotors, and an electric motor; a manifold having one ends each being in fluid communication with the bottommost second rotor; a rotor and generator assembly having one end being in fluid communication with the other end of the manifold, the rotor and generator assembly comprising a plurality of units each including a main rotor having a first valve, a bypass pipe interconnecting both ends thereof, the bypass pipe having a second valve at a forward joining portion thereof and the main rotor, and a first generator driven by the main rotor; and a feedback pipe having one end connected to the other end of the rotor and generator assembly and the other ends connected to the first rotors respectively.

### BACKGROUND OF THE INVENTION

1. Field of Invention

The invention relates to wind turbines and more particularly to such a wind turbine capable of continuously generating electricity in a substantially stable fashion (i.e., without sharp decrease of power production).

2. Description of Related Art

Wind turbines are well known devices for transforming wind energy into electrical energy. One drawback of the conventional wind turbines is that they are intermittent power sources. This means that the power production from a wind turbine may increase or decrease dramatically over a short period of time. In this regard, the balance of the grid must be able to quickly compensate for this change.

There have been numerous suggestions in prior patents for wind turbine. For example, U.S. Pat. No. 5,518,362 discloses a wind power station. Thus, continuing improvements in the exploitation of wind turbine are constantly being sought.

### SUMMARY OF THE INVENTION

It is therefore one object of the invention to provide a wind turbine capable of continuously generating electricity in a substantially stable fashion without sharp decrease of the power production.

The above and other objects, features and advantages of the invention will become apparent from the following detailed description taken with the accompanying drawings.

### BRIEF DESCRIPTION OF THE DRAWINGS

FIG. 1 is a perspective view of a wind turbine according to the invention;

FIG. 2 is an exploded view of some components of the superposed rotor assembly of FIG. 1;

FIG. 3 is an exploded view of the unit of the rotor and generator assembly and its associated components shown in FIG. 1; and

FIG. 4 is a schematic longitudinal sectional view of the wind turbine shown in FIG. 1.

### DETAILED DESCRIPTION OF THE INVENTION

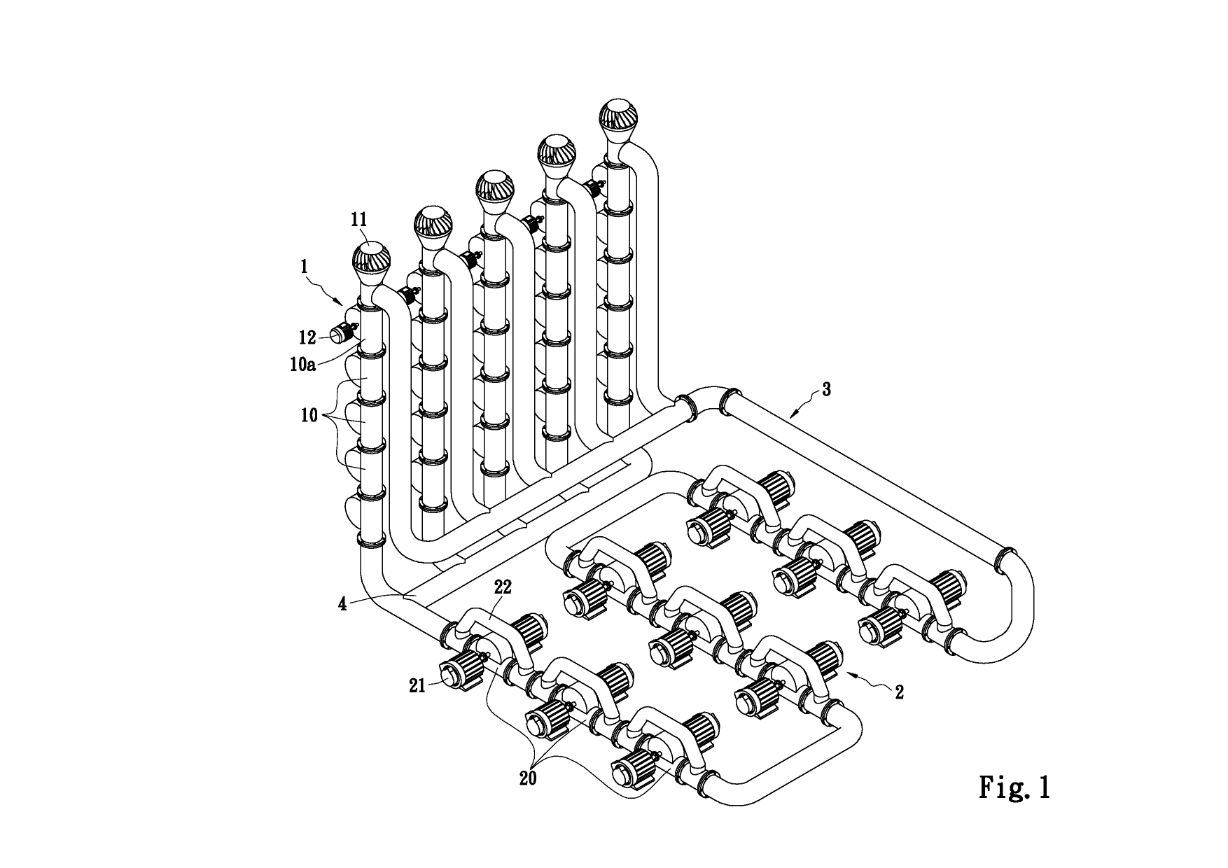

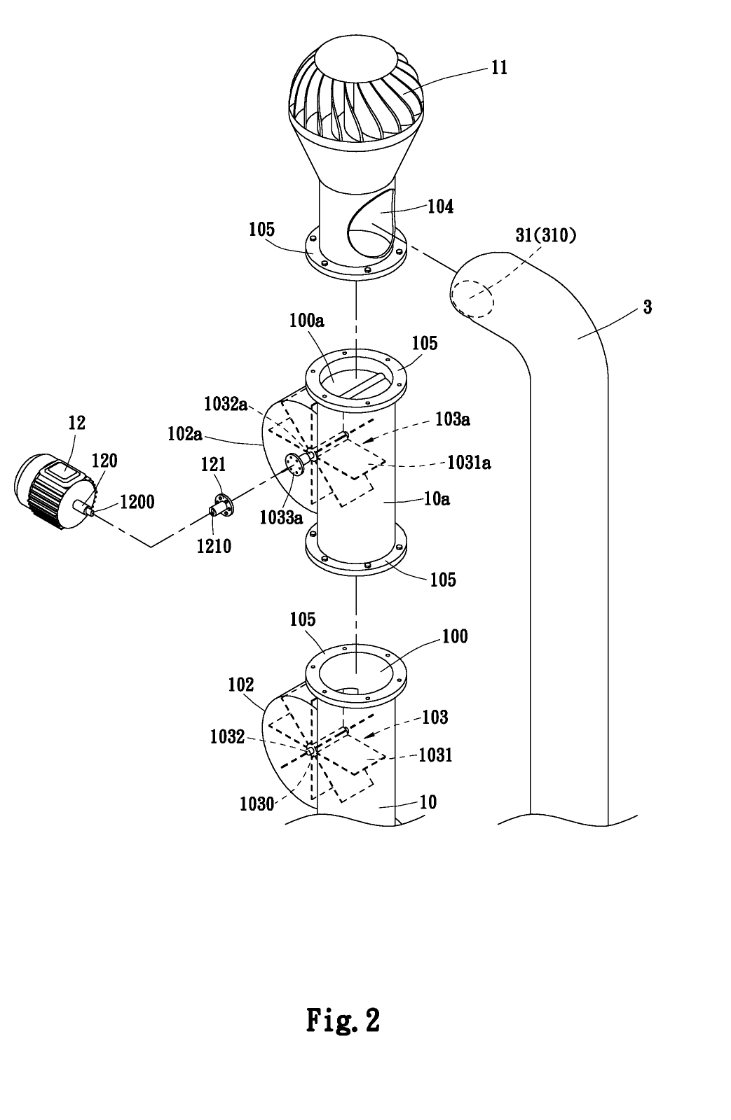

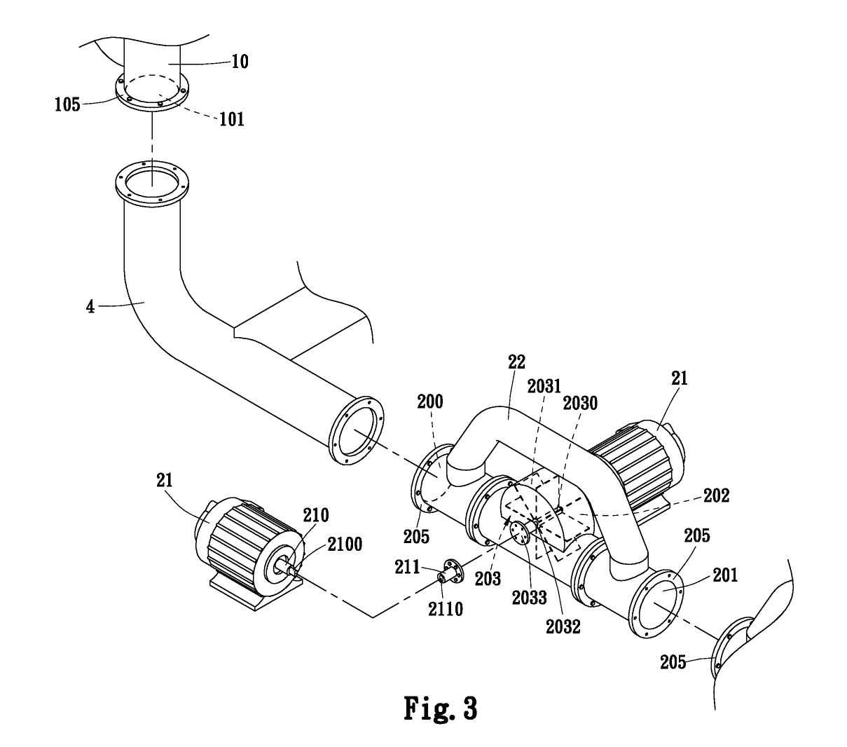

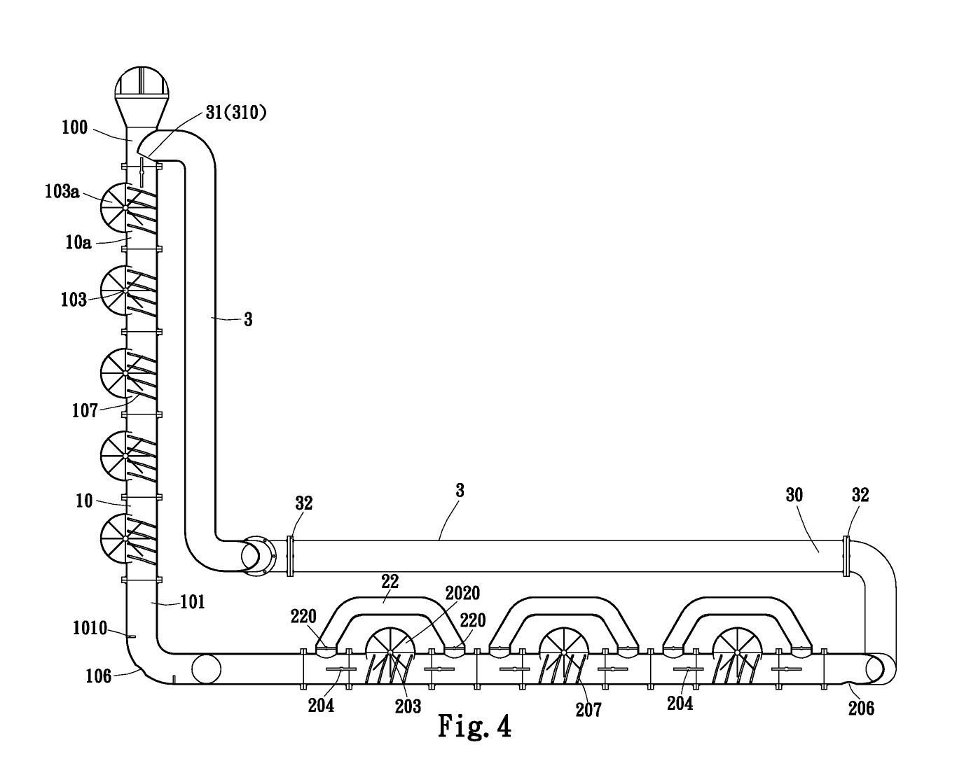

Referring to FIGS. 1 to 4, a wind turbine in accordance with a preferred embodiment of the invention comprises the following components as discussed in detail below.

Five upright superposed rotor assemblies 1 each comprises a top multi-vane rotor 11; and an upper first rotor unit 10a including an axial channel 100a, top and bottom flanges 105, a half cylindrical casing 102a extending out of the first rotor unit 10a, and an auxiliary rotor 103a disposed in both the first rotor unit 10a and the casing 102a and including a plurality of blades 1031a fixedly secured to a drive shaft 1032a, and a flange 1033a at one end of the drive shaft 1032a.

The superposed rotor assembly 1 further comprises an electric motor 12 including a drive shaft 120 extending therefrom, the drive shaft 120 having an end projection 1200, and a flange 121 threadedly secured to the flange 1033a and having a slot 1210 matingly secured to the end projection 1200.

The superposed rotor assembly 1 further comprises four lower second rotor units 10 each including an axial channel 100, top and bottom flanges 105, a half cylindrical casing 102 extending out of the first rotor unit 10, and an auxiliary rotor 103 disposed in both the second rotor unit 10 and the casing 102 and including a plurality of blades 1031 fixedly secured to a drive shaft 1032, and a boss 1030 on either end of the drive shaft 1032. The top flange 105 of the topmost one of the second rotor units 10 is threadedly secured to the bottom flange 105 of the first rotor unit 10a. The bottom flange 105 of any second rotor unit 10 is threadedly secured to the top flange 105 of the second rotor unit 10 therebelow (if any). Note that the bottom flange 105 of the bottommost second rotor unit 10 is threadedly secured to a flange (not numbered) at one of a plurality of ends of a manifold 4.

The manifold 4 has one ends being in fluid communication with the bottom openings 101 of the bottommost ones of the second rotor units 10. A rotor and generator assembly 2 comprises three groups of three units 20 in which two adjacent groups are coupled together by a pipe. Each unit 20 comprises a first pipe opening 200 at one end, a second pipe opening 201 at the other end, and two flanges 205 at both ends; a bypass pipe 22 having one end valve 220 connected to one pipe end and the other end valve 220 connected to the other pipe end; a half cylindrical casing 202 extending out of an intermediate section of the unit 20; a main rotor 203 disposed in both the intermediate section of the unit 20 and the casing 202 and including a plurality of blades 2031 fixedly secured to a drive shaft 2032, a boss 2030 at either end of the drive shaft 2032 (only one boss 2030 shown), and a flange 2033 at either end of the drive shaft 2032 (only one flange 2033 shown); and two generators 21 at both sides of the unit 20, each generator 21 including a drive shaft 210 extending therefrom, the drive shaft 210 having an end projection 2100, and a flange 211 threadedly secured to the flange 2033 at either end of the drive shaft 2032 and having a slot 2110 matingly secured to the end projection 2100.

The flange 205 at one end of one unit 20 is threadedly secured to the other end of the manifold 4. The flange 205 at the other end of one unit 20 is threadedly secured to the flange 205 at one end of an adjacent unit 20. In such a manner, the units 20 are coupled together. The other end of one of the units 20 is threadedly secured to a flange 32 at the other end 30 of a feedback pipe 3 which has five one ends 31 with an opening 310. One end 31 of the feedback pipe 3 is secured to the lower opening 104 so that the feedback pipe 3 can communicate fluid with the multi-vane rotors 11.

The operation of the wind turbine is as follows. First, the electric motors 12 are activated to rotate the auxiliary rotors 103a. The superposed rotor assemblies 1 thus have an internal pressure lower than the atmospheric pressure. And in turn, wind stream is sucked and directed to the bottoms of the superposed rotor assemblies 1 via the multi-vane rotors 11 and the first rotor unit 10a and the second rotor units 10 in which the blades 1031a and 1031 are rotated by the wind stream. As a result, wind strength is greatly increased. The wind stream entering the main rotor 203 one by one to rotate the blades 2031. The generators 21 thus begin to generate electricity. The wind stream leaving the rotor and generator assembly 2 enters the feedback pipe 3. Finally, the wind stream leaves one ends 31 of the feedback pipe 3 and enters the multi-vane rotors 11 via the lower openings 104. This is one cycle of the wind stream through the wind turbine.

Gradually, internal pressure of each superposed rotor assembly 1 increases. The electric motors 1 2 can be deactivated if the internal pressure of each superposed rotor assembly 1 reaches a predetermined value. This can be done by comparing a value measured by a pressure gauge (not shown) in the rotor and generator assembly 2 with a predetermined value of the atmospheric pressure. The wind turbine still maintains its normal operation by directing wind stream to the superposed rotor assemblies 1 via the multi-vane rotors 11 after shutting down the electric motors 12. That is, the generators 21 continue to generate electricity. It is envisaged by the invention that the wind turbine is capable of continuously generating electricity in a substantially stable fashion without sharp decrease of power production. In short, the wind turbine is implemented as a continuous power source even when the wind strength is decreased greatly.

In a normal operation of the wind turbine, the valves 220 of the bypass pipes 22 are closed and valves 204 of the units 20 are open. An employee may open the valves 220 of one bypass pipe 22 and close the valve 204 of the unit 20 if the unit 20 malfunctions. As such, wind stream may bypass the malfunctioned unit 20 to enter an immediately next unit 20 by passing the bypass pipe 22 of the malfunctioned unit 20. This ensures that the wind turbine can maintain its normal operation even if one or more units 20 are malfunctioned.

A first drain port 106 is provided in the lower bending portion of each superposed rotor assembly 1. Further, a second drain port 206 is provided in, for example, a portion of the rotor and generator assembly 2 connecting the feedback pipe 3. The drain ports 106, 206 allow a full draining of water from the superposed rotor assemblies 1 and the rotor and generator assembly 2 respectively so as to maintain the normal operation of the wind turbine.

A first heating element 107 is provided on an inner surface of each superposed rotor assembly 1. Further, a second heating element 207 is provided on an inner surface of the rotor and generator assembly 2. The provision of the heating elements 107, 207 ensures that the wind turbine can function normally even in a low temperature environment.

While the invention herein disclosed has been described by means of specific embodiments, numerous modifications and variations could be made thereto by those skilled in the art without departing from the scope and spirit of the invention set forth in the claims.

What is claimed is:

1. A wind turbine for transforming wind energy into electrical energy, comprising:
a plurality of superposed rotor assemblies each comprising a top first rotor, a plurality of second rotors, and an electric motor;
a manifold having one ends each being in fluid communication with the bottommost second rotor;
a rotor and generator assembly having one end being in fluid communication with the other end of the manifold, the rotor and generator assembly comprising a plurality of units each including a main rotor having a first valve which is open in a normal operation, a bypass pipe interconnecting both ends thereof, the bypass pipe having a second valve at a forward joining portion thereof and the main rotor, the second valve being closed in the normal operation, and a first generator driven by the main rotor; and
a feedback pipe having one end connected to the other end of the rotor and generator assembly and the other ends connected to the first rotors respectively,
wherein the electric motors are activated to rotate the topmost second rotors so that the second motors have an internal pressure lower than a predetermined pressure to direct wind stream through the second rotors via the first rotors for rotation; the wind stream leaving the second rotors enters the main rotors for rotation so that the generators can generate electricity; and the wind stream leaving the rotor and generator assembly enters respective joining portions of the first rotors and the topmost second rotors via the feedback pipe;
wherein the electric motors are deactivated when the internal pressures of the second rotors are equal to the predetermined pressure with the generators continuing to generate electricity; and
wherein in response to one of the units being malfunctioned the first valve thereof can be closed and the second valve thereof can be open to cause the wind stream to bypass the malfunctioned unit.

2. The wind turbine of claim 1, further comprising a plurality of second generators each driven by the main rotor and disposed opposing the first generator.

3. The wind turbine of claim 1, further comprising a first drain port disposed in a lowest portion of the superposed rotor assemblies, and a second drain port disposed in the rotor and generator assembly.

4. The wind turbine of claim 1, further comprising a plurality of first heating elements each disposed on an inner surface of the superposed rotor assembly, and at least one second heating element disposed on an inner surface of the rotor and generator assembly.
